(19) United States
(12) Patent Application Publication
(10) Pub. No.: US 2020/0082306 A1
(43) Pub. Date: Mar. 12, 2020

(54) RECORDING MEDIUM RECORDING SIMULATION PROGRAM, SIMULATION METHOD, AND INFORMATION PROCESSING APPARATUS

(71) Applicant: FUJITSU LIMITED, Kawasaki-shi (JP)

(72) Inventors: Hiroaki Yamada, Kawasaki (JP); Kotaro Ohori, Chuo (JP); Shohei Yamane, Kawasaki (JP)

(73) Assignee: FUJITSU LIMITED, Kawasaki-shi (JP)

(21) Appl. No.: 16/684,181

(22) Filed: Nov. 14, 2019

Related U.S. Application Data
(63) Continuation of application No. PCT/JP2017/018401, filed on May 16, 2017.

(51) Int. Cl. G06Q 10/04; G06Q 10/06

(52) U.S. Cl. CPC G06Q 10/047; G06Q 10/06375; G06Q 10/067

(57) ABSTRACT

A non-transitory computer-readable recording medium records a simulation program for causing a computer to execute a process which includes: selecting an appreciation target, when an agent of an appreciation behavior for a plurality of exhibits appreciates a first exhibit, based on a relative position with respect to the agent and a congestion status, from among the first exhibit and exhibits as an appreciation candidate other than the first exhibit; when the appreciation target is the first exhibit, causing the agent to continue appreciation; and when the appreciation target is a second exhibit other than the first exhibit, causing the agent to move to the second exhibit.

### CROSS-REFERENCE TO RELATED APPLICATION

This application is a continuation application of International Application PCT/JP2017/018401 filed on May 16, 2017 and designated the U.S., the entire contents of which are incorporated herein by reference.

### FIELD

The embodiments discussed herein are related to a simulation program, a simulation method, and a simulation apparatus.

### BACKGROUND

A people flow simulation is used to consider an arrangement plan for arranging exhibits so as to reduce congestion in an event space such as a gallery or a museum.

A related art is disclosed by Okada, M., Motegi, Y., Yamamoto, K., (2011), in Human Swarm Modeling in Exhibition Space and Space Design, IEEE/RSJ International Conference on Intelligent Robots and Systems.

### SUMMARY

According to an aspect of the embodiments, a non-transitory computer-readable recording medium records a simulation program for causing a computer to execute a process which includes: selecting an appreciation target, when an agent of an appreciation behavior for a plurality of exhibits appreciates a first exhibit, based on a relative position with respect to the agent and a congestion status, from among the first exhibit and exhibits as an appreciation candidate other than the first exhibit; when the appreciation target is the first exhibit, causing the agent to continue appreciation; and when the appreciation target is a second exhibit other than the first exhibit, causing the agent to move to the second exhibit.

The object and advantages of the invention will be realized and attained by means of the elements and combinations particularly pointed out in. the claims.

It is to be understood that both the foregoing general description and the following detailed description are exemplary and explanatory and are not restrictive of the invention.

### BRIEF DESCRIPTION OF DRAWINGS

FIG. 1 is a block diagram exemplifying a configuration of a simulation apparatus according to an embodiment;

FIG. 2 is an explanatory diagram for explaining space information;

FIG. 3 is an explanatory diagram for explaining exhibit information;

FIG. 4 is an explanatory diagram for explaining appreciator information;

FIG. 5 is a flowchart illustrating an operation example of the simulation apparatus according to the embodiment;

FIG. 6 is a flowchart illustrating an example of a simulation process;

FIG. 7 is an explanatory diagram for explaining a calculation of an expected utility;

FIG. 8 is an explanatory diagram for explaining an example of behaviors of an agent;

FIG. 9 is an explanatory diagram for explaining an example of behaviors of the agent;

FIG. 10 is an explanatory diagram for explaining an example of behaviors of the agent;

FIG. 11 is an explanatory diagram or explaining an example of behaviors of the agent;

FIG. 12 is an explanatory view for explaining a display screen of an output result;

FIG. 13 is an explanatory view for explaining a display screen of an output result;

FIG. 14 is an explanatory view for explaining a display screen of an output result; and

FIG. 15 is a block diagram illustrating an example of a hardware configuration of the simulation apparatus according to the embodiment,

### DESCRIPTION OF EMBODIMENTS

In this people flow simulation, exhibits according to the arrangement plan and agents imitating appreciators are arranged in a virtual space corresponding to a gallery, a museum, or the like. By simulating behaviors of the agents based on information acquired (recognized) from the virtual space, flows of people in the arrangement plan are simulated.

For the agents in the people flow simulation, the probability of selecting an exhibit to view is determined based on the proximity of the exhibit, the number of people viewing, and the distance from an exit. A behavior model is proposed such that the degree of satisfaction increases as the exhibit as an appreciation target becomes close, a walking speed becomes slower as the degree of satisfaction increases quickly, and the appreciator moves to the next exhibit when the degree of satisfaction reaches a certain value.

In this behavior model, a behavior of selecting an exhibit to be appreciated next is introduced according to a degree of congestion indicated by the number of people viewing, the proximity from the current location, and the distance to the exit, to thereby reproduce a congestion avoidance behavior, and enlargement of a congestion to the surroundings triggered by a congestion occurring at a certain location by this behavior is reproduced.

However, in the above-mentioned prior art, there is a problem that it is difficult to accurately reproduce a people flow in which a backtrack occurs.

For example, since an actual appreciator may want to efficiently enhance an appreciation experience, if an exhibit next to the exhibit being currently appreciated becomes less crowded, the appreciation target may be changed to that exhibit. If an exhibit that is previously an appreciation target becomes less crowded, the appreciator may return to the appreciation target. Such a behavior appears as a backtrack to move back and forth between exhibits. Since this backtrack may be a trigger to cause a new congestion to form, it is desirable to reproduce backtracks of appreciators in order to consider whether the arrangement plan concerned reduces congestion,

For example, a selection of the appreciation target is made when the appreciator finishes appreciation of the first exhibit and moves to a new exhibit. Thus, a backtrack such as temporarily suspending appreciation and moving to a non-congested exhibit, or appreciating an exhibit of which appreciation have been suspended before after appreciating another exhibit, is not reproduced. Therefore, it is difficult to reproduce a congestion formation triggered by the backtrack.

In an aspect of the embodiments, a simulation program, a simulation method, and a simulation apparatus capable of reproducing the flow of people in which the backtrack occurs may be provided.

Hereinafter, a simulation program, a simulation method, and a simulation apparatus according to embodiments will be described with reference to the drawings. Configurations having the same functions in the embodiments are denoted by the same reference signs, and redundant descriptions will be omitted. Note that the simulation program, the simulation method, and the simulation apparatus to be described in the following embodiments are merely examples, and the embodiments are not limited thereto. Each embodiment below may be appropriately combined within the scope of no contradiction.

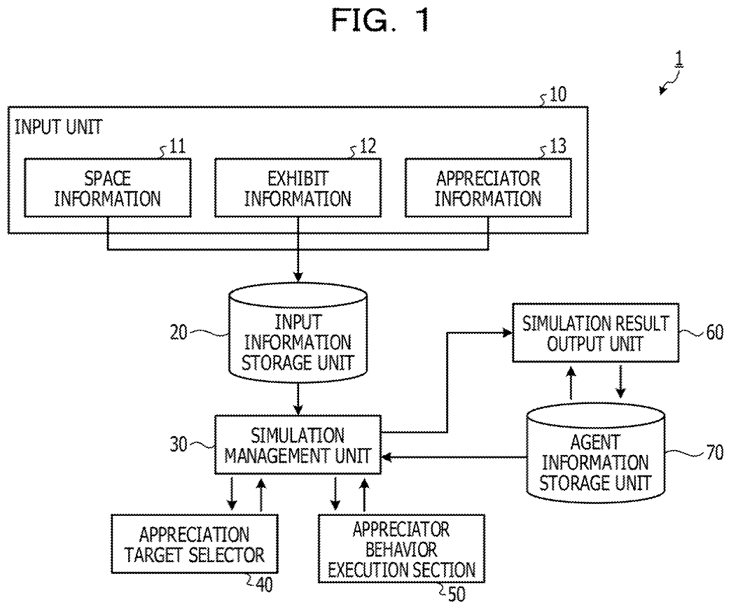

FIG. 1 is a block diagram depicting a configuration of a simulation apparatus 1 according to an embodiment. The simulation apparatus 1 illustrated in FIG. 1 is, for example, an information processing apparatus such as a personal computer (PC). The simulation apparatus 1 performs a people flow simulation that reproduces, by a simulation process using a pedestrian agent corresponding to an appreciator (hereinafter referred to as an agent), an appreciation behavior of the appreciator with respect to a plurality of exhibits placed in a virtual space based on input information, and imitates the flow of appreciators. As illustrated in FIG. 1, the simulation apparatus 1 includes an input unit 10, an input information storage unit 20, a simulation management unit 30, an appreciation target selector 40, an appreciator behavior execution section 50, a simulation result output unit 60, and an agent information storage unit 70.

The input unit 10 receives input information related to the simulation, such as space information 11, exhibit information 12, and appreciator information 13, from an input device, for example, a mouse and/or a keyboard.

The input information storage unit 20 stores input information such as the space information 11, the exhibit information 12, and the appreciator information 13 which are input from the input unit 10, in a storage device such as a random access memory (RAM) or a hard disk drive (HDD).

The space information 11 is information indicating the structure of a virtual space involved in a simulation of a gallery, a museum, or the like. For example, the space information 11 describes a cell environment with respect to a virtual space (size, the number of floors, walls, passages, positions of facilities, and the like) in which an agent corresponding to an appreciator walks around in the simulation and a network environment related to connection of nodes (passages, facilities, and the like) in the space. A user inputs, to the simulation apparatus 1, the space information 11 of the virtual space to be considered in the simulation.

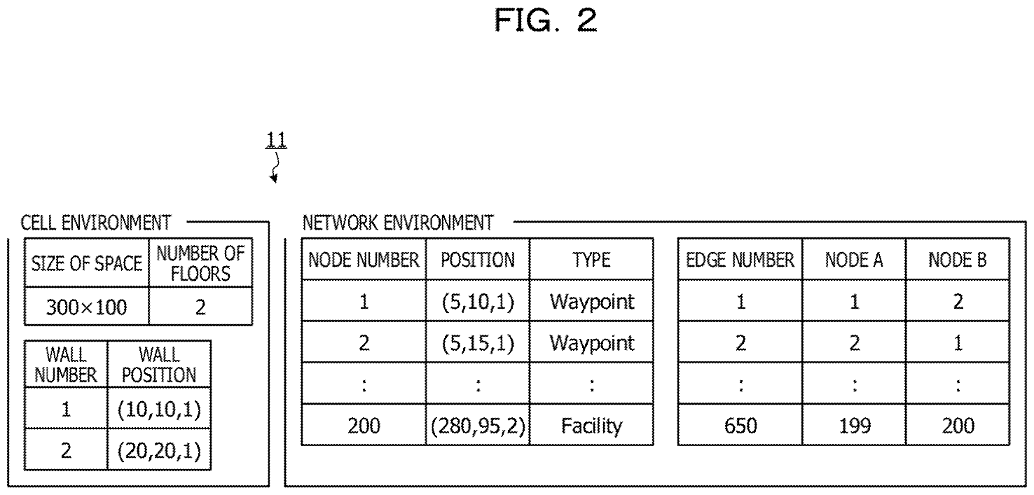

FIG. 2 is an explanatory diagram for explaining the space information 11. As illustrated in FIG. 2, the space information 11 describes a cell environment such as the area of a virtual space, the number of floors, wall numbers indicating cells (walls) where the agent does not proceed, and the positions of the walls. Further, the space information 11 describes a network environment such as coordinates of node, a walking goal (Waypoint), and a type of node such as facility (Facility), for each node number indicating a node. The network environment describes an edge number and node numbers indicating nodes connected to each other for each edge between nodes where movements are allowed.

The exhibit information 12 is information indicating an arrangement position and content of the exhibit to be arranged in a gallery, a museum, or the like. For example, the exhibit information 12 describes, for each exhibit, identification information identifying an exhibit (for example, a uniquely assigned exhibit number, or the like), the coordinate position of the exhibit in the virtual space, and the like. The user inputs, to the simulation apparatus 1, the exhibit information 12 in which an arrangement plan is reflected based on, for example, an arrangement plan of the exhibit to be considered in the simulation.

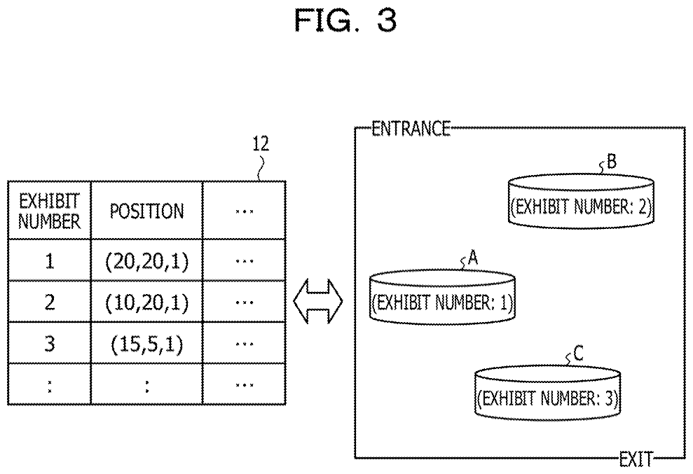

FIG. 3 is an explanatory diagram for explaining the exhibit information 12. As illustrated in FIG. 3, in the exhibit information 12, information such as the position of each exhibit is described for each exhibit number identifying the exhibit.

The appreciator information 13 is information indicating an agent corresponding to an appreciator. For example, the appreciator information 13 is information on occurrence probability of an agent occurring at an appearance point corresponding to an exit and entrance or the like in a virtual space, and information on the type of an agent to be occurred. The type of an agent is, for example, gender such as male or female, or an age group such as children (infant, elementary, junior high, and senior high school students), or adults (20 to 40 years old, 40 to 60 years old, and 60 years old or older). The user inputs, to the simulation apparatus 1, the appreciator information 13 about the appreciator to be considered in the simulation.

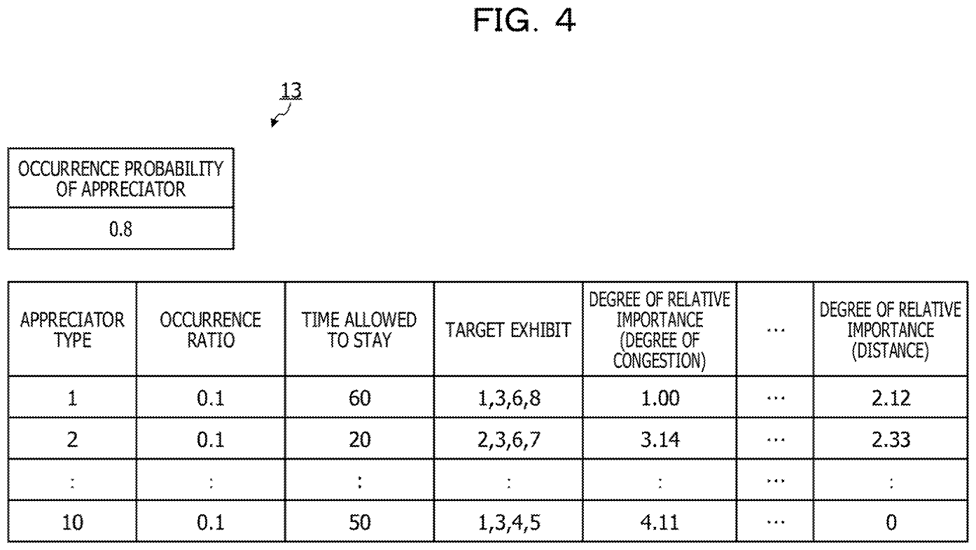

FIG. 4 is an explanatory diagram for explaining the appreciator information 13. As illustrated in FIG. 4, the appreciator information 13 describes an occurrence probability of an agent (appreciator) and characteristics (natures) of an occurring agent for each number indicating an appreciator type.

As the occurrence probability, for example, a value corresponding to the number of appreciators who enter from the entrance of the virtual space per unit time is set.

The characteristics of the agent include “occurrence ratio”, “the allowed to stay”, “target exhibit”, and “degree of relative importance (congestion)” . . . “relative importance (distance)”, and the like. The characteristics of the agent are not limited to the above items. For example, in addition to the above items, items such as a walking speed of an agent may be further included in characteristics of the agent.

The “occurrence ratio” indicates the ratio of occurrence of each agent. The “time allowed to stay” indicates a time allowed to stay for each agent in the virtual space. For example, each agent sequentially appreciates target exhibits from the time of entry at the entrance and moves toward the exit when the time allowed to stay becomes close, thereby behaving so as to reach the exit within the set time allowed to stay.

The “target exhibit” lists, in the order of priority, values indicating exhibits to be targets of appreciation for each agent. For example, in a case where the “target exhibit” is “1, 3, 6, and 8”, the priority of the exhibit is set in the order of exhibit numbers 1, 3, 6, and 8.

The “degree of relative importance (congestion)” . . . “degree of relative importance (distance)” indicate relative importance to which element each agent gives importance when selecting an exhibit to be appreciated, among elements such as a degree of congestion of an exhibit and distance to the exhibit. As an example, in this embodiment, a degree of relative importance of each element is set for the degree of congestion (c) of an exhibit, the distance (d) from the current position of an agent to the exhibit, and the distance (e) from the exit to the exhibit. For example, for an agent who gives greater importance to the degree of congestion (c) of an exhibit than other elements, a value higher than the degrees of relative importance of (d) and (e) is set as the degree of relative importance of (c).

As the contents of the appreciator information 13, there are input values assumed for an appreciator who visits a virtual space related to a simulation of a gallery, a museum, or the like. For example, if use by adults (20 to 40 years old, 40 to 60 years old) is high and use by children (infant, elementary, junior high, and senior high school students) is low, the occurrence ratio of the appreciator type corresponding to adults is set large, and the occurrence ratio of the appreciator type corresponding to children is set small.

The simulation management unit 30 manages processes for simulating behaviors of each agent in the virtual space in every unit time that are performed in the appreciation target selector 40 and the appreciator behavior execution section 50 based on the input information (the space information 11 the exhibit information 12, and the appreciator information 13) stored in the input information storage unit 20. For example, the simulation management unit 30 reads out the input information stored in the input information storage unit 20 and results of sequentially simulating behaviors of respective agents (positions and states of respective agents) stored in the agent information storage unit 70, and outputs the results to the appreciation target selector 40 and the appreciator behavior execution section 50,

The simulation management unit 30 outputs results of sequentially simulating behaviors of respective agents (positions and states of respective agents) performed in the appreciation target selector 40 and the appreciator behavior execution section 50 in every unit time to the simulation result output unit 60.

The appreciation target selector 40 executes a process of selecting an exhibit as an appreciation target for each agent based on the input information stored in the input information storage unit 20 and the position and state of each agent stored in the agent information storage unit 70.

For example, for each agent, the appreciation target selector 40 extracts an exhibit present in a range (for example, in the same room) that each agent can perceive based on the position of each agent stored in the agent information storage unit 70 and the position of the exhibit indicated by the exhibit information 12. Next, the appreciation target selector 40 takes an exhibit corresponding to the target exhibit indicated by the appreciator information 13 among the extracted exhibits as an appreciation candidate, and creates a set of appreciation candidates for each agent.

Next, the appreciation target selector 40 selects, for each agent, an exhibit as the appreciation target out of the exhibits included in the set of appreciation candidates based on a relative position with respect to the agent and a congestion status of the exhibit.

For example, the appreciation target selector 40 obtains the relative position between the agent and each exhibit based on the position of each agent stored in the agent information storage unit 70 and the position of each exhibit in the exhibit information 12. Similarly, based on the position of each agent stored in the agent information storage unit 70 and the position of each exhibit in the exhibit information 12, the appreciation target selector 40 obtains a congestion status for each exhibit by counting the number of agents within a predetermined distance from the exhibit.

Next, the appreciation target selector 40 calculates an expected value of utility (hereinafter referred to as an expected utility) that the agent can obtain for each of the exhibits included in the set of appreciation candidates based on the obtained relative position between the agent and each exhibit and the obtained congestion status of each exhibit. Next, the appreciation target selector 40 selects an exhibit having the largest expected utility among the exhibits included in the set of appreciation candidates as the exhibit as the appreciation target.

The process of selecting the exhibit as the appreciation target in the appreciation target selector 40 is repeatedly performed in every unit time for each agent regardless of the state of the agent (for example, while appreciating an exhibit or moving). For this reason, for an agent appreciating a certain exhibit, the exhibit being appreciated is selected as it is as the appreciation target and the appreciation continues in some cases, or another exhibit is selected as the exhibit as the appreciation target in some other cases. As described above, the appreciation target selector 40 is an example of a selector,

The appreciator behavior execution section 50 executes, for each agent, a behavior of the agent which causes the agent to move to the exhibit selected by the appreciation target selector 40, and to appreciate the exhibit when the agent has approached the exhibit by a predetermined distance.

For example, based on the position and state of each agent stored in the agent information storage unit 70, the appreciator behavior execution section 50 allows the agent to continue appreciation of the exhibit when the agent is appreciating the exhibit as the appreciation target selected by the appreciation target selector 40.

In the appreciation behavior of the exhibit by each agent, the appreciator behavior execution section 50 increases the degree of satisfaction, among the states of the agent, that indicates the degree of satisfaction with respect to the exhibit being appreciated. For example, for an agent appreciating an exhibit, the degree of satisfaction of the exhibit being appreciated is increased by a predetermined amount per unit time.

The amount of increase in the degree of satisfaction per unit time may be changed according to the congestion status of the exhibit being appreciated, which is obtained based on the position of each agent stored in the agent information storage unit 70 and the position of the exhibit in the exhibit information 12. As an example, since it is not possible to approach the surroundings of the exhibit when congested, the amount of increase in the degree of satisfaction per unit time is reduced as compared to a case where it is possible to further approach the exhibit. As described above, the appreciator behavior execution section 50 may change the amount of increase in the degree of satisfaction (the quality of appreciation experience) according to the allowable distance for approaching the exhibit based on the congestion status of the exhibit.

Next, if the degree of satisfaction exceeds a threshold set in advance in each agent, the appreciator behavior execution section 50 removes the exhibit being appreciated from the set of appreciation candidates. Consequently, the appreciator behavior execution section 50 moves the agent having appreciated until fully satisfied to another exhibit.

In addition, the appreciator behavior execution section 50 may change the threshold for evaluating the degree of satisfaction according to the remaining time allowed to stay of each agent (the time obtained by subtracting an elapsed time from entering the virtual space from the time allowed to stay in the appreciator information 13). For example, the threshold may be reduced according to the ratio of the remaining time allowed to stay in the time allowed to stay. By changing the threshold value in this manner, the simulation apparatus 1 can reproduce the appreciation behavior of the agent in accordance with the remaining time allowed to stay.

When the exhibit as the appreciation target selected by the appreciation target selector 40 based on the position and state of each agent stored in the agent information storage unit 70 is other than the exhibit being appreciated, the appreciator behavior execution section 50 moves the agent to the selected exhibit as the appreciation target.

For example, the appreciator behavior execution section 50 moves the agent along a path with a shortest moving distance based on, the position of the agent stored in the agent information storage unit 70 and the position of the exhibit as the appreciation target selected by the exhibit information 12. Next, the appreciator behavior execution section 50 starts appreciating the exhibit when the agent has approached the position of the exhibit as the appreciation target by a predetermined distance,

The appreciator behavior execution section 50 returns, to the simulation management unit 30, the position and state of each agent (moving or appreciating an exhibit, the degree of satisfaction with each exhibit, a threshold, and the like) obtained as a result of the above simulation. As described above, the appreciator behavior execution section 50 is an example of a behavior execution section.

The simulation result output unit 60 stores results of sequentially simulating behaviors of agents (positions and states of respective agents) in the agent information storage unit 70. The simulation result output unit 60 outputs the simulation results stored in the agent information storage unit 70 by displaying on a display device or printing with a printing device. As this output of the simulation results, the results of sequentially performed simulations may be sequentially output. An aggregation result of simulation results performed over a predetermined time may be output.

The agent information storage unit 70 stores information (positions and states) of respective agents, which are results of sequential simulations, in a storage device such as a RAM or an HDD. The agent information storage unit 70 stores results of sequential simulations by adding identification information (such as a file name, for example) thereto by each scenario in which the number of appreciators entered per unit time or the like is changed, and by each measure in which the position of the exhibit or the like is changed. Thus, the agent information storage unit 70 stores simulation results by each condition of the simulation in which the scenario and the measure are changed.

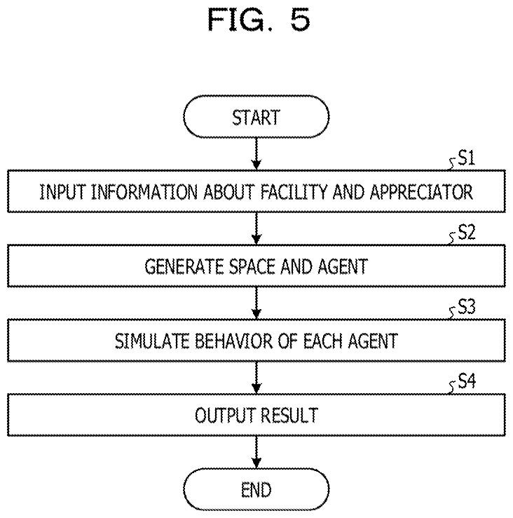

Next, details of operation of the simulation apparatus 1 will be described. FIG. 5 is a flowchart illustrating an operation example of the simulation apparatus 1 according to the embodiment.

As illustrated in FIG. 5, when a process is started, the input unit 10 receives an information input about a facility or an appreciator, for example, an input of the space information 11, the appreciator information 13, and the exhibit information 12, and stores the input information in the input information storage unit 20 (S1). Next, the simulation management unit 30 generates a virtual space in which exhibits are arranged and generates an agent for each time based on the space information 11, the exhibit information 12, and the appreciator information 13 that are input (S2).

For example, the simulation management unit 30 generates a virtual space in which exhibits are arranged based on the space information 11 and the exhibit information 12. The simulation management unit 30 also generates an agent corresponding to an appreciator at an entrance in the virtual space based on an occurrence probability in the appreciator information 13 and an occurrence ratio for each appreciator type.

Next, the appreciation target selector 40 and the appreciator behavior execution section 50 execute a simulation process for sequentially simulating behaviors of respective agents generated in the virtual space (S3).

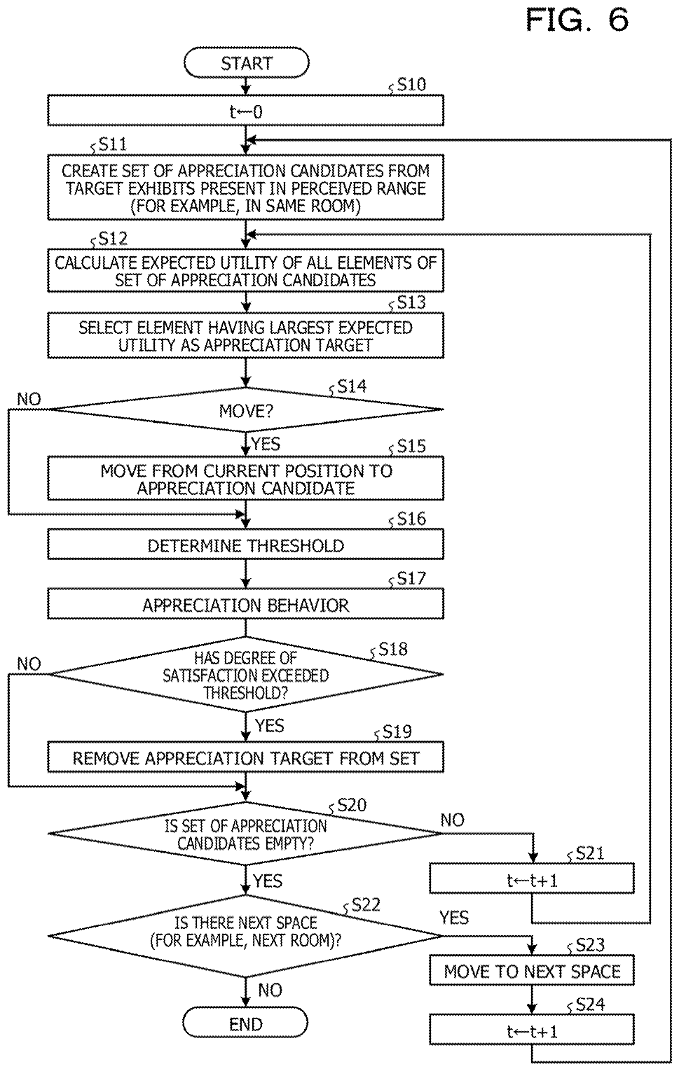

FIG. 6 is a flowchart illustrating an operation example of the simulation process. As illustrated in FIG. 6, when the process is started, the appreciation target selector 40 and the appreciator behavior execution section 50 initialize a time (t) taken for the simulation process (t←0) (S10).

Then, for each agent, the appreciation target selector 40 creates a set of appreciation candidates from target exhibits present in a range perceivable by each agent (for example, in the same room) based on the position of each agent stored in the agent information storage unit 70 and the positions of exhibits indicated by the exhibit information 12 (S11).

Next, for each agent, the appreciation target selector 40 calculates an expected utility for all elements of the set of appreciation candidates, for example, for each of the exhibits included in the set of appreciation candidates (S12).

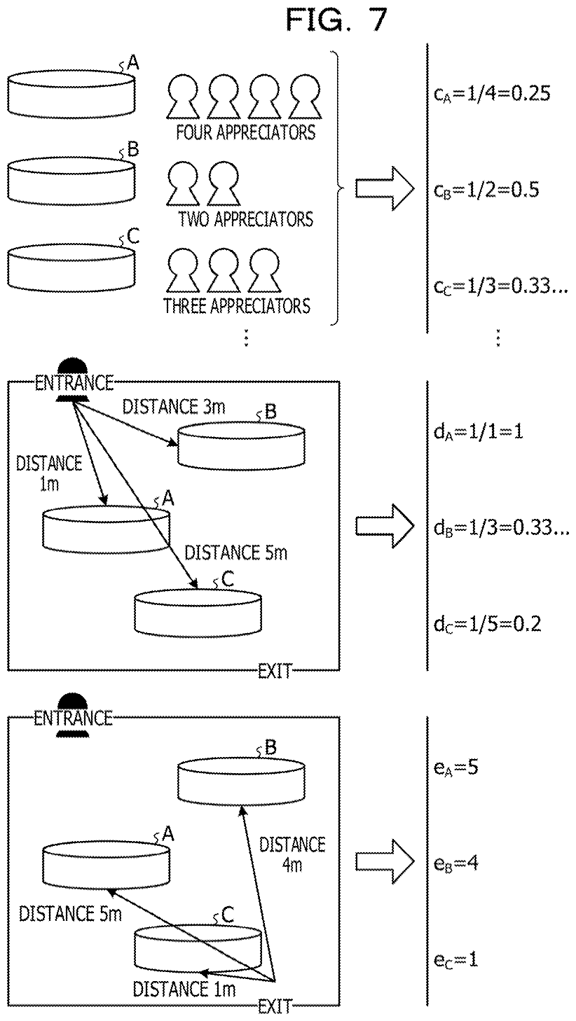

FIG. 7 is an explanatory diagram for explaining calculation of the expected utility. In the example of FIG. 7, it is assumed that exhibits A to C are included in the set of appreciation candidates.

As illustrated in FIG. 7, the appreciation target selector 40 obtains the number of appreciators for the exhibits A to C by counting the number of agents within a predetermined distance from the exhibits A to C based on the positions of respective agents stored in the agent information storage unit 70 and the positions of respective exhibits in the exhibit information 12. Next, the appreciation target selector 40 obtains degrees of congestion C_{A} to C_{C} indicating congestion statuses with respect to the exhibits A to C by obtaining the reciprocal of the obtained number of appreciators or the like.

Based on the positions of respective agents stored in the agent information storage unit 70 and the positions of the exhibits A to C in the exhibit information 12, the appreciation target selector 40 obtains distances from the agent positions to the exhibits A to C. Next, the appreciation target selector 40 obtains evaluation values d_{A} to d_{C} that evaluate the distances from the agent to the exhibits A to C larger (evaluate to be better for the agent) as the distance is closer by obtaining the reciprocals of the obtained distances or the like.

Similarly, the appreciation target selector 40 obtains the distances e_{A} to e_{C} from the exit to the exhibits A to C based on the positions of the exhibits A to C in the exhibit information 12. About the distances to the exit, the closer to the exit, the better evaluation is given.

Next, with reference to the degree of relative importance in the appreciator information 13, the appreciation target selector 40 obtains degrees of relative importance of each of the degree of congestion (c) of the exhibit, the distance (d) from the current location of the agent to the exhibit, and the distance (e) from the exit to the exhibit. Next, the appreciation target selector 40 obtains expected utilities (EU_{A} to EU_{C}) of the exhibits A to C by multiplying the calculated degrees of congestion C_{A} to C_{C}, the evaluation values d_{A} to d_{C}, and the distances e_{A} to e_{C} by their respective degrees of relative importance, and then adds up the results.

For example, it is assumed that the respective degrees of relative importance (c, d, and e) of the degree of congestion (c) of an exhibit, the distance (d) from the current location of an agent to the exhibit, and the distance (e) from the exit to the exhibit are (5, 1, and 0.1). In this case, the expected utilities EU_{A} to EU_{C} may be obtained as follows from values of the degrees of congestion C_{A} to C_{C}, the evaluation values d_{A} to d_{C}, and the distances e_{A} to e_{C} in FIG. 7.

EU_{A}=5×0.25+1×1+0.1×5=2.75

EU_{B}=5×0.5+1×0.33+0.1×4=3.23

EU_{C}=5×033+1×0.2+0.1×1=1.95

In calculation of the expected utility in each of the above-mentioned exhibits, the appreciation target selector 40 may take into consideration the degree of satisfaction of the agent on each of the exhibits based on the state of the agent stored in the agent information storage unit 70. General appreciators tend to have a strong desire for appreciation for an exhibit with a low degree of satisfaction. For example, for an exhibit which is appreciated once and satisfied with a high degree of satisfaction, the desire for appreciation is low compared to an unappreciated exhibit. Therefore, a behavior according to the degree of satisfaction of the appreciator can be reproduced by selecting an appreciation target based on the expected utility with the degree of satisfaction on each of the exhibits being taken into consideration.

For example, the appreciation target selector 40 expresses the strength of a desire for an exhibit of the agent as a value as (predetermined threshold)−(current degree of satisfaction). The appreciation target selector 40 may obtain the expected utility of the exhibit by multiplication by the degree of relative importance with respect to this value and adding up the result.

Similarly, the appreciation target selector 40 may obtain the expected utility of an exhibit by an appreciation experience of the exhibit by the agent. For example, based on the information (position and state) of the agent in the agent information storage unit 70, the appreciation target selector 40 obtains, for each exhibit, the presence or absence of an appreciation experience by a function that outputs 0 (zero) if the exhibit is appreciated at least once or 1 if the exhibit is never appreciated. The appreciation target selector 40 then multiplies the expected utility of each exhibit by the value corresponding to the presence or absence of the appreciation experience. This makes it possible to reproduce the behavior of the appreciator according to the presence or absence of the appreciation experience with respect to each exhibit.

Referring back to FIG. 6, after S12, the appreciation target selector 40 selects an element (exhibit) having the largest expected utility in the set of appreciation candidates as an appreciation target (S13).

Next, the appreciator behavior execution section 50 determines whether or not to move the agent based on the selection result of the appreciation target selector 40 and the position and state of each agent stored in the agent information storage unit 70 (S14). For example, when the agent is appreciating the exhibit as the appreciation target selected by the appreciation target selector 40, the appreciator behavior execution section 50 determines that the agent does not move (NO in S14), and advances the process to S16.

In addition, when the exhibit as the appreciation target selected by the appreciation target selector 40 is other than the exhibit being appreciated, the appreciator behavior execution section 50 determines that the agent moves (YES in S14). When the agent moves, the appreciator behavior execution section 50 moves the agent from the current position to the exhibit as the appreciation target (S15).

Next, the appreciator behavior execution section 50 determines a threshold for evaluating the degree of satisfaction concerning appreciation of the exhibit based on the remaining time the agent is allowed to stay (S16). The appreciator behavior execution section 50 then carries out, for each agent, an appreciation behavior on the exhibit as the appreciation target, and increases the degree of satisfaction with the exhibit being appreciated (S17).

Next, the appreciator behavior execution section 50 determines whether the degree of satisfaction on the exhibit being appreciated exceeds a threshold or not (S18). When the degree of satisfaction does not exceed the threshold (NO in S18), the appreciator behavior execution section 50 advances the process to S20. When the degree of satisfaction exceeds the threshold (YES in S18), the appreciator behavior execution section 50 removes the exhibit as the appreciation target from the set of appreciation candidates (S19).

Next, the appreciator behavior execution section 50 determines whether the set of appreciation candidates is empty or not (S20). If the set of appreciation candidates is not empty (NO in S20), the appreciator behavior execution section 50 increments the time (t) taken for the simulation process (t←t+1), returns the process to S12 (S21), and advances the process to the next time.

If the set of appreciation candidates is empty (YES in S20), the appreciator behavior execution section 50 refers to the space information 11 and determines whether there is a next space (for example, a next room) or not (522). If there is a next space (YES in S22), the appreciator behavior execution section 50 moves the agent to the next space (S23), increments the time (t) taken for the simulation process (t←t+1), and returns the process to 511 (S24),

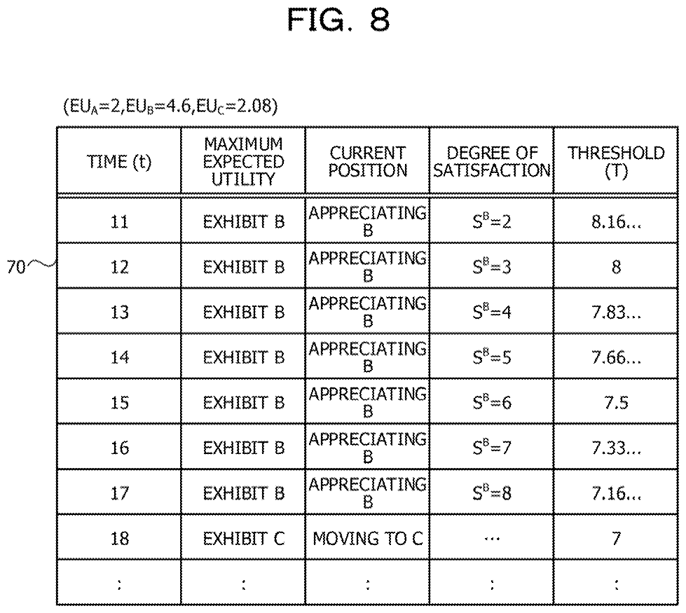

FIGS. 8 to 11 are explanatory diagrams for explaining an example of behaviors of an agent. For example, in FIGS. 8 to 11, the position and state of a certain agent stored in the agent information storage unit 70 are described in chronological order.

FIG. 8 exemplifies behaviors of the agent in a case where the degree of congestion does not change with time (fixed as EU_{A}=2, EU_{B}=4.6, and EU_{C}=2.08). As illustrated in FIG. 8, when the degree of congestion does not change with time, the appreciation behavior of the agent is continued from the exhibit B with a high expected utility until the degree of satisfaction exceeds the threshold. The degree of satisfaction exceeds the threshold at time t=17 and thus the exhibit B is deleted from the set of appreciation candidates. Accordingly, the exhibit C with the next highest expected utility to the exhibit B becomes the appreciation target, and the agent starts moving to the exhibit C.

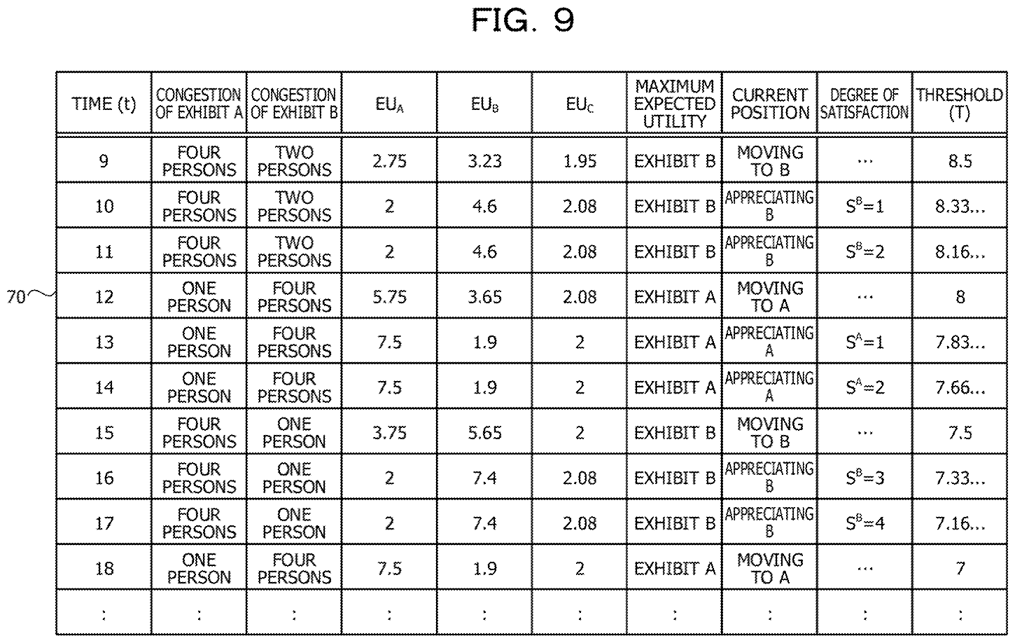

FIG. 9 exemplifies behaviors of the agent when the degrees of congestion of the exhibits A and B change with time. As illustrated in FIG. 9, when the degrees of congestion of the exhibits A and B change with time, the values of EU_{A} and EU_{B} may increase or decrease with a passage of time, and the high-low relationship between EU_{A} and EU_{B} may be reversed. Accordingly, the appreciation target of the agent changes from the exhibit B to the exhibit A (t12), appreciation of the exhibit. B is temporarily suspended (the exhibit B is kept included in the set of appreciation candidates), and the agent moves to the appreciation of the exhibit A. Thereafter, the appreciation target of the agent changes from the exhibit A to the exhibit B (t15), and the agent returns to the exhibit B of which appreciation is temporarily suspended. For example, a flow of people in which a backtrack occurs is reproduced.

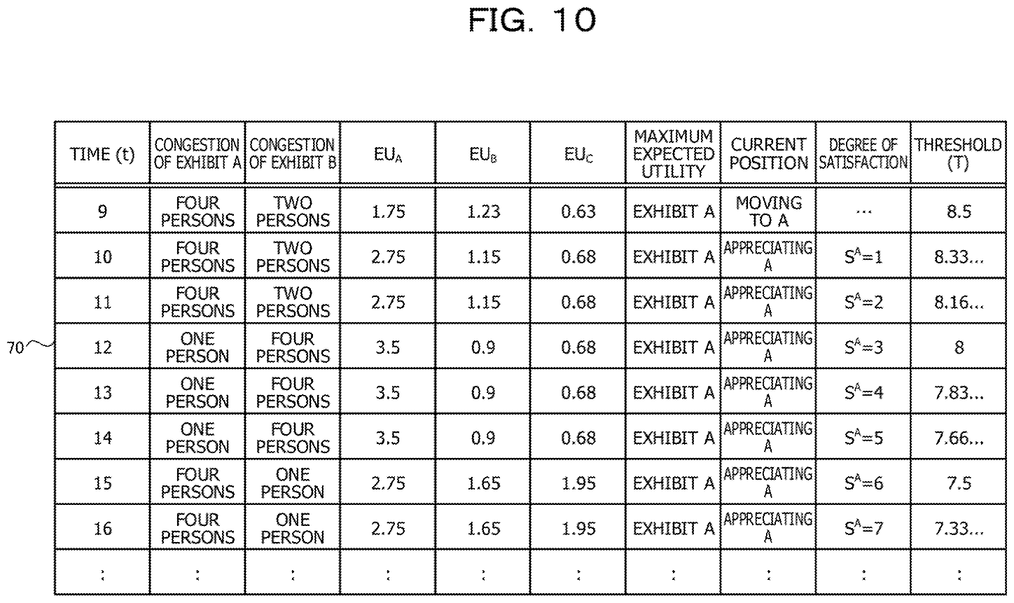

FIG. 10 exemplifies behaviors of the agent in a case where the degree of relative importance of the degree of congestion (c) in the agent is lower than that in FIG. 9, and a congestion avoidance intention is weak (the other conditions are the same as in FIG. 9). As illustrated in FIG. 10, even if the degrees of congestion of the exhibits A and B change with time, if the degree of relative importance of the degree of congestion (c) in the agent is low, inversion of the high-low relationship between EU_{A} and EU_{B} hardly occurs. Thus, due to characteristics of the agent, such as a low congestion avoidance intention, the behavior of the appreciator of a type that does not cause a backtrack is reproduced.

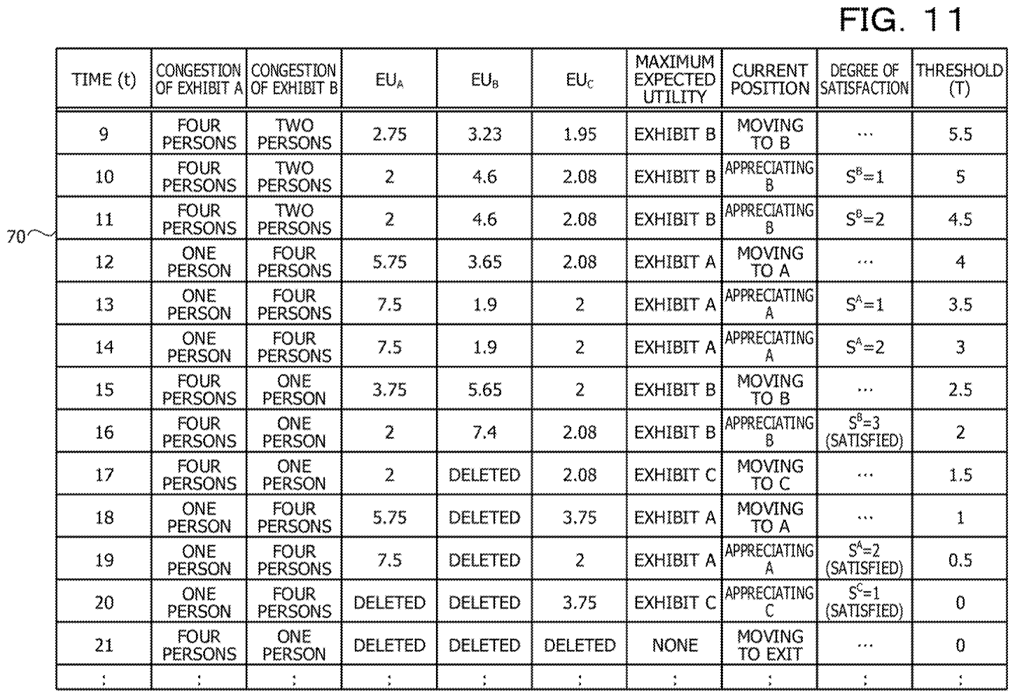

FIG. 11 illustrates behaviors of the agent in a case where the time the agent is allowed to stay is shorter than in the example of FIG. 9 (other conditions are the same as in FIG. 9). As illustrated in FIG. 11, since a threshold (T) for evaluating the degree of satisfaction related to appreciation of an exhibit is determined based on the remaining time the agent is allowed to stay, the threshold becomes a lower value as the time the agent is allowed to stay becomes shorter. Accordingly, in the example of FIG. 11, the way of backtrack is different (the backtrack occurs frequently) compared to the example of FIG. 9. That is, a complex behavior of an appreciator that changes in behavior pattern depending on the situation is reproduced, such that a backtrack does not occur so much when the time allowed to stay is long, but a backtrack occurs frequently when the time allowed to stay is short.

Referring back to FIG. 5, after the simulation processing (S3), the simulation result output unit 60 outputs an aggregation result of simulation results stored in the agent information storage unit 70, for example, on a screen of a display device (S4). Thus, the user may easily confirm the aggregation result of the simulation.

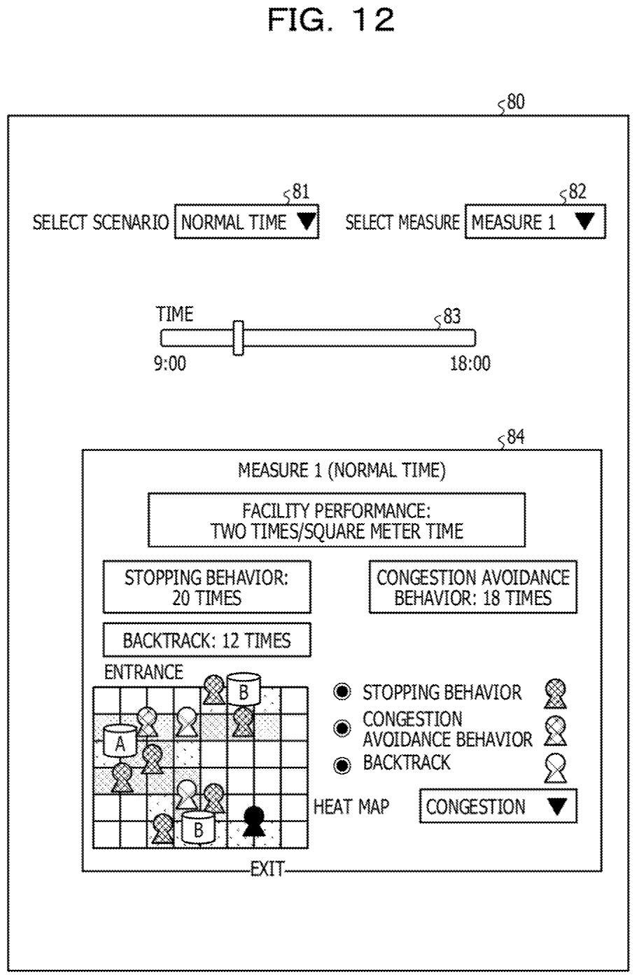

FIGS. 12 to 14 are explanatory diagrams for explaining display screens of output results. As illustrated in FIG. 12, a display screen 80 has, for example, pull-down menus 81 and 82, a seek bar 83, and a result display area 84.

The pull-down menus 81 and 82 accept selection of simulation conditions such as scenarios and measures. As a scenario, for example, whether it is a situation that an average appreciator (such as an adult) frequently visits or a situation that a non-average appreciator (such as an elderly person or a child) frequently visits is selected. As a measure, for example, an arrangement plan to arrange popular exhibits near the entrance or an arrangement plan to arrange popular exhibits near a wall away from the entrance is selected. By selecting an exhibit arrangement plan of interest in the measure and selecting one of various possible situations of appreciators in the scenario (which change depending on the season, time, and the presence of event), it is possible to evaluate the effect of a measure in a conceivable scenario in an exploratory manner. The simulation result output unit 60 reads simulation results of the conditions selected in the pull-down menus 81 and 82 from the agent information storage unit 70 and displays the simulation results in the result display area 84.

The seek bar 83 receives the selection of a time between the start and the end of the simulation. The simulation result output unit 60 reads out the state of each agent at the time selected by the seek bar 83 and an aggregation result up to that time from the agent information storage unit 70 and displays the result in the result display area 84.

The result display area 84 is an area that displays the state of each agent at the time selected by the seek bar 83 and the aggregation result up to the time selected by the seek bar 83 based on the simulation result according to the simulation conditions selected in the pull-down menus 81 and 82.

The simulation result output unit 60 refers to, for example, the position and state of each agent stored in the agent information storage unit 70, and displays in the display area 84 the status of stay and congestion by aggregation according to definition contents set in advance.

For example, “congestion” is defined as a state such that a state that a predetermined number of people (for example, three people) or more stays in 1 m² continues for a predetermined time (for example, five minutes) or more.

“Faulty performance”, which is the performance of the arrangement of exhibits, is defined as the number of occurrences of congestion (the number of occurrences per hour)/total floor space (m²) from the number of occurrences of congestion during one hour taking into consideration a situation where a group of average appreciators visits. “Risk” that congestion occurs at a certain location (a heat map with hatching in the illustrated example) is defined as the number of times congestion occurs (number of times per hour) at this location (1 m²).

“Potential risk” where congestion occurs at a certain location is defined as follows from the number of occurrences of congestion during one hour considering the situation that a group of appreciators who are not average visits.

First, assuming that a non-average situation is an abnormal situation where congestion is likely to occur, for example, a situation where a large number of appreciators of a predetermined type (such as elderly person or child) visit is taken as a condition of the simulation. Under such a condition, elderly people and children are simulated as having a slow moving speed and thus cause congestion. Under the condition of this abnormal situation, the number of times congestion has occurred in the location of interest (1 m²) (the number of times per hour) is taken as the potential risk.

“Stopping behavior”, “congestion avoidance behavior”, and “backtrack”, which are behaviors causing congestion, are defined as follows.

The “stopping behavior” is defined as a state that (appreciation target selected at time t−1)=(appreciation target selected at time t) and the moving speed at time t is 0.

For the “congestion avoidance behavior”, an expected utility (EU) obtained with a term of the degree of congestion and an expected utility (EU′) obtained without the term of the degree of congestion are obtained. It is defined that a congestion avoidance behavior has occurred if the exhibit selected when using the EU and the exhibit selected when using the EU′ are different.

The “backtrack” is defined as moving to another appreciation target even though the degree of satisfaction of a certain appreciation target has not reached the threshold in a situation where the appreciation target is selected (while keeping the appreciation target in the set of appreciation candidates), and moving back to the appreciation target.

The simulation result output unit 60 aggregates the simulation results stored in the agent information storage unit 70 according to these definitions, and displays the result in the result display area 84, thereby visualizing the status of staying and congestion and presenting it to the user. For example, the simulation result output unit 60 again selects an exhibit that an agent 85 has appreciated before as the appreciation target, and displays the result of aggregating “backtrack” of moving to this exhibit in the result display area 84. As described above, the simulation result output unit 60 is an example of the output unit. Thus, the user may easily confirm the “backtrack” situation.

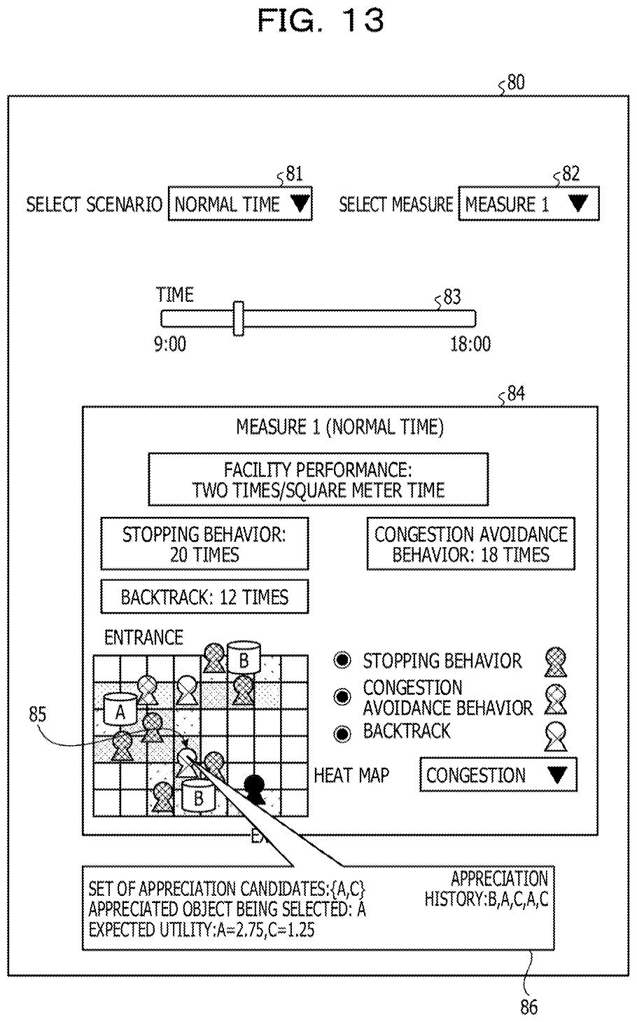

Further, as illustrated in FIG. 13, when a predetermined agent 85 in the result display area 84 is selected, the simulation result output unit 60 reads a simulation result related to the selected agent 85 from the agent information storage unit 70, and displays agent information 86. As an example, the agent information 86 includes a set of appreciation candidates at a time point during seek, an appreciation history, an appreciated object (exhibit) being selected, a value of expected utility in the selected agent 85, and the like. Thus, the user may confirm the state of each agent.

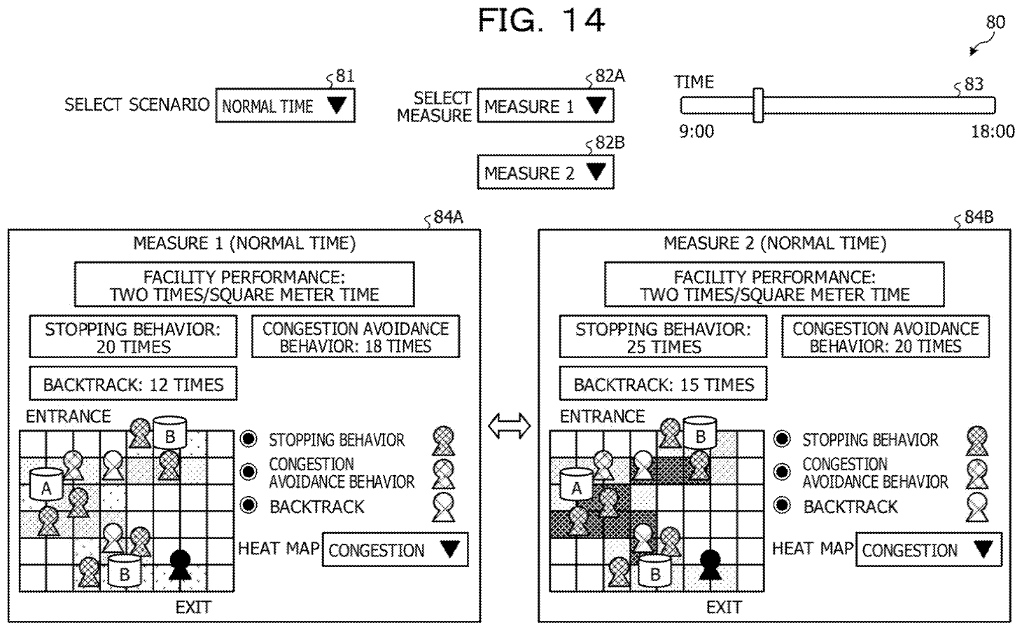

The simulation result output unit 60 may display simulation results under different simulation conditions from each other side by side on the display screen 80. For example, as illustrated in FIG. 14, the simulation result output unit 60 displays respective simulation results with different measures selected in the pull-down menus 82A and 826 side by side in the result display areas 84A and 84B on the display screen 80. Thus, the user may easily compare simulation results under different simulation conditions from each other.

As described above, the simulation apparatus 1 is an apparatus for executing a simulation process using an agent of appreciation behaviors for a plurality of exhibits, and has an appreciation target selector 40 and an appreciator behavior execution section 50. The appreciation target selector 40 performs a process of selecting, for each agent, an exhibit as an appreciation target based on a relative position with respect to the agent and a congestion status, while the agent is appreciating a first exhibit (for example, an exhibit A), out of the first exhibit and exhibits as an appreciation candidate (for example, exhibits B, C) other than the first exhibit. For each agent, the appreciator behavior execution section 50 continues appreciation when the appreciation target is a first exhibit being appreciated, and performs a process to move to a second exhibit when the appreciation target is the second exhibit other than the first exhibit.

Therefore, the simulation apparatus 1 can reproduce the flow of people causing a backtrack in an appreciation behavior of the appreciator (agent). For example, in the simulation apparatus 1, an appreciation behavior of an appreciator may be reproduced such that if an exhibit next to the exhibit being currently appreciated becomes less crowded, the appreciation target is changed to this exhibit, and if an exhibit that is a previous appreciation target becomes less crowded, the appreciation target is returned to this exhibit.

It is not always necessary that the respective components of the illustrated apparatuses are physically configured as illustrated in the drawings. That is, the specific aspects of separation and integration of each of the apparatuses are not limited to the illustrated aspects, and all or part thereof can be functionally or physically separated and integrated in any unit in accordance with various loads, use status, and the like.

All or any part of various processing functions to be performed by the simulation apparatus 1 may be executed by a central processing unit (CPU) (or a microcomputer such as a micro processing unit (MPU) or a micro controller unit (MCU)). It is needless to say that all or any part of various processing functions may be executed on a program to be analyzed and executed on a CPU (or a microcomputer such as MPU or MCU), or on hardware by wired logic. Various processing functions executed in the simulation apparatus 1 may be executed by a plurality of computers in cooperation though cloud computing.

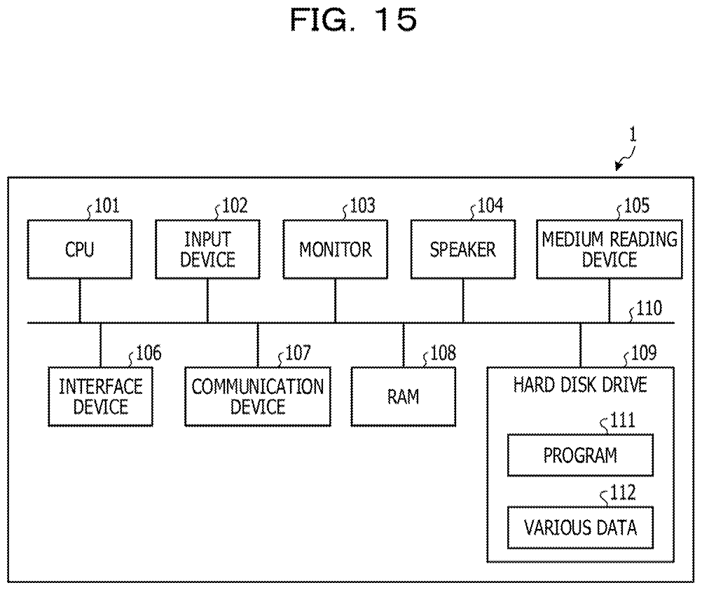

Meanwhile, the various types of processing described in the above embodiment can be achieved by execution of a program prepared in advance on a computer. Thus, there will be described below an example of a computer (hardware) that executes a program with functions similar to the functions in the above embodiment. FIG. 15 is a block diagram illustrating an example of a hardware configuration of the simulation apparatus 1 according to the embodiment.

As illustrated in FIG. 15, the simulation apparatus 1 includes a CPU 101 that executes various types of arithmetic processing, an input device 102 that receives data input, a monitor 103, and a speaker 104. The simulation apparatus 1 has a medium reading device 105 that reads a program and the like from a storage medium, an interface device 106 that is used for connecting to various devices, and a communication device 107 for communicably connecting with an external device in a wired or wireless manner. The simulation apparatus 1 has a RAM 108 which temporarily stores various types of information and a hard disk drive 109. Additionally, each part (101 to 109) in the simulation apparatus 1 is connected to a bus 110.

The hard disk drive 109 stores a program 111 for executing various types of processing described in the above embodiment. The hard disk drive 109 also stores various types of data 112 which the program 111 refers to. The input device 102 receives, for example, an input of operation information from an operator of the simulation apparatus 1. The monitor 103 displays, for example, various screens operated by the operator. The interface device 106 is connected to, for example, a printing device or the like. The communication device 107 is connected to a communication network such as a local area network (LAN), and exchanges various types of information with an external device via the communication network.

The CPU 101 reads the program 111 stored in the hard disk drive 109 and loads the program 111 into the RAM 108 to execute the program 111, thereby executing various types of processing. The program 111 does not need to be stored in the hard disk drive 109. For example, the program 111 stored in a storage medium which is readable by the simulation apparatus 1 may be read and executed by the simulation apparatus 1. The storage medium which is readable by the simulation apparatus 1 corresponds to, for example, a portable recording medium such as a compact disc read only memory (CD-ROM), a digital versatile disc (DVD), a portable recording medium such as a universal serial bus (USB) memory, a semiconductor memory such as a flash memory, a hard disk drive, and the like. Alternatively, this program may be stored in a device connected to a public line, the Internet, a LAN, or the like, and the simulation apparatus 1 may read the program from the device to execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium recording a simulation program for causing a computer to execute a process, the process comprising:
selecting an appreciation target, when an agent of an appreciation behavior for a plurality of exhibits appreciates a first exhibit, based on a relative position with respect to the agent and a congestion status, from among the first exhibit and exhibits as an appreciation candidate other than the first exhibit;
when the appreciation target is the first exhibit, causing the agent to continue appreciation; and
when the appreciation target is a second exhibit other than the first exhibit, causing the agent to move to the second exhibit.

2. The non-transitory computer-readable recording medium according to claim 1, wherein the process further includes:
setting a degree of satisfaction which is increased by appreciation for each of the exhibits; and
removing an exhibit for which the set degree of satisfaction is equal to or more than a predetermined value from the exhibits as the appreciation candidate.

3. The non-transitory computer-readable recording medium according to claim 2, wherein
the selecting further selects the appreciation target based on the degree of satisfaction for each of the exhibits.

4. The non-transitory computer-readable recording medium according to claim 1, wherein the process further includes:
selecting an exhibit which is previously appreciated by the agent as an appreciation target again; and
outputting a result of aggregating movements of e agent including information of moving to the selected exhibit.

5. The non-transitory computer-readable recording medium according to claim 1, wherein
the selecting further selects the appreciation target based on a distance of each of the exhibits to an exit.

6. A simulation method comprising:
selecting, by a computer, an appreciation target, when an agent of an appreciation behavior for a plurality of exhibits appreciates a first exhibit, based on a relative position with respect to the agent and a congestion status, from among the first exhibit and exhibits as an appreciation candidate other than the first exhibit;
when the appreciation target is the first exhibit, causing the agent to continue appreciation; and
when the appreciation target is a second exhibit other than the first exhibit, causing the agent to move to the second exhibit.

7. The simulation method according to claim 6, further comprising:
setting a degree of satisfaction which is increased by appreciation for each of the exhibits; and
removing an exhibit for which the set degree of satisfaction is equal to or more than a predetermined value from the exhibits as the appreciation candidate.

8. The simulation method according to claim 7, wherein
the selecting further selects the appreciation target based on the degree of satisfaction for each of the exhibits.

9. The simulation method according to claim 6, further comprising selecting an exhibit which is previously appreciated by the agent as an appreciation target again, and outputting a result of aggregating movements of the agent including information of moving to the selected exhibit,

10. The simulation method according to claim 6, wherein
the selecting further selects the appreciation target based on a distance of each of the exhibits to an exit.

11. An information processing apparatus comprising:
a memory; and
a processor coupled to the memory and configured to:
select an appreciation target, when an agent of an appreciation behavior for a plurality of exhibits appreciates a first exhibit, based on a relative position with respect to the agent and a congestion status, from among the first exhibit and exhibits as an appreciation candidate other than the first exhibit;
when the appreciation target is the first exhibit, cause the agent to continue appreciation; and
when the appreciation target is a second exhibit other than the first exhibit, cause the agent to move to the second exhibit.

12. The information processing apparatus according to claim 1 wherein
the processor is further configured to:
set a degree of satisfaction which is increased by appreciation for each of the exhibits, and
remove an exhibit for which the set degree of satisfaction is equal to or more than a predetermined value from the exhibits as the appreciation candidate.

13. The information processing apparatus according to claim 12, wherein
the processor is further configured to select the appreciation target based on the degree of satisfaction for each of the exhibits.

14. The information processing apparatus according to claim 11, wherein
the processor is further configured to:
select an exhibit which is previously appreciated by the agent as an appreciation target again; and
output a result of aggregating movements of the agent including information of moving to the selected exhibit.

15. The information processing apparatus according to claim 11, wherein
the processor is further configured to select the appreciation target based on a distance of each of the exhibits to an exit.
